(19) United States
(12) Patent Application Publication
(10) Pub. No.: US 2008/0053805 A1
(43) Pub. Date: Mar. 6, 2008

(54) POWER TOOL

(76) Inventor: Helmut WANEK, Kirchheim/Neckar (DE)

Correspondence Address: RONALD E. GREIGG;GREIGG & GREIGG P.L.L.C., 1423 POWHATAN STREET, UNIT ONE, ALEXANDRIA, VA, 22314, US

(21) Appl. No.: 11/837,046

(22) Filed: Aug. 10, 2007

(30) Foreign Application Priority Data
Aug. 30, 2006 (DE) 10 2006 040 647.8

(51) Int. Cl. H01H 19/00

(52) U.S. Cl. 200/336

(57) ABSTRACT

The invention describes a power tool having at least one contactless switch element that includes at least one sensor element and at least one signal transducer, and having an actuating means for actuating the switch element; the sensor element or the signal transducer can be connected rigidly to the actuating means.

### CROSS REFERENCE TO RELATED APPLICATIONS

This application is based on German Patent Application No. 10 2006 040 647.8 filed 30 Aug. 2006, upon which priority is claimed.

### BACKGROUND OF THE INVENTION

1. Field Of The Invention

The invention relates to a power tool comprising an improved contactless switch.

2. Description of the Prior Art

For switching present electric tools on and off electromechanical switches are used, in which two contacts are connected to one another or disconnected by mechanical actuation. The circuit is closed or interrupted accordingly. However, switches that function in contactless fashion are known as well. For instance, in German Patent Disclosure DE 102 59 569 A1, an electric power tool with a contactless manual electric switch that has an actuating means and a sensor switch is described; the sensor switch is connected in a vibration-free manner to an at least pivotable switchgear holder and can be controlled manually by way of a pivoting transmission means, in the form of a rotary pivoting coupling of actuating means. With the actuating means in the form of a slide switch, a transformation of motion between the linearly limitedly displaceable actuating means and the rotationally pivotable switchgear holder is effected by way of a coupling guide, in the form of a guide slot extending radially to the pivot axis. The switchgear is embodied as a permanent magnet, while the sensor switch is embodied as a Hall sensor.

### SUMMARY OF THE INVENTION

The power tool of the invention includes at least one contactless switch element that in turn includes at least one sensor element and at least one signal transducer. A contactless switch element is considered to be a switch element whose contact elements, that is, the sensor element and signal transducer, are connected or disconnected without mechanical contact. The switch element is preferably used for switching the electric motor of the power tool on and off. However, a lighting device, such as an LED, for illuminating the work area or some other electrical or electronic component of the power tool can also be switched on and off with the switch element. For actuating the switch element, the power tool furthermore includes an actuating means that can be actuated manually by the user of the power tool. A switch device of the invention includes at least one contactlessly functioning switch element and one actuating means. According to the invention, in the power tool, the sensor element or the signal transducer is embodied such that it can be connected rigidly to the actuating means. This is advantageous, since the construction of the switch device comprising the switch element and actuating means is simple and comprises only a few components. In particular, in comparison to the electric power tool disclosed in DE 102 59 569 A1, no coupling or joint parts are necessary for accomplishing a transformation of motion between a linearly movable actuating means and a rotationally pivotable switchgear holder.

In a first embodiment, the sensor element and the signal transducer are embodied as movable linearly relative to one another. In particular, the sensor element and the signal transducer can be moved axially relative to one another. Because of the linear, and in particular axial, movability of the sensor element and the signal transducer relative to one another, safe, reliable and precise activation and deactivation of an electrical or electronic component are possible.

As a result, the sensor element and the signal transducer can be embodied as linearly and in particular axially movable relative to one another in that either the sensor element is stationary and the signal transducer is movable linearly, particularly axially, or the signal transducer is stationary while the sensor element is movable linearly, in particular axially. Alternatively, both the sensor element and the signal transducer may be embodied as movable linearly, particularly axially, relative to one another. In a preferred embodiment, the sensor element is stationary, in particular being structurally connected to the housing, while the signal transducer is embodied as axially movable.

The signal transducer is also preferably movable counter to the compressive force of a spring element. The spring element is preferably a helical spring, but it may also be some other type of spring element, such as a leaf spring.

In a preferred embodiment of the power tool of the invention, the signal transducer can be connected to a slide, for instance by being secured to a slide. The slide is axially displaceable by means of a guide element. A guide element may for instance be a guide sleeve or a guide rail. To move the signal transducer axially and thus put it into contact with the sensor element, the slide is in turn connectable to the actuating means that can be actuated by hand by the user of the power tool. The actuating means is positioned for instance in the region of the handle of the power tool in such a way that the user grasps the handle with one hand and places one finger of his hand, as a rule his index finger, on the actuating means. The actuating means is actuated by being pressed, causing it to move axially.

According to the invention, the sensor element or the signal transducer is rigidly connected to the actuating means; preferably, the signal transducer is rigidly connected to the actuating means via a slide. Thus the actuating means is also embodied as axially movable. The slide can be connected nondetachably or detachably to the actuating means in various ways, for instance by adhesive bonding, by clips or snaps, or by engagement from behind. Alternatively, the slide may be embodied in one piece with the actuating means. The part that is actuatable manually by the user is considered to be the actuating means, regardless of whether the actuating means is embodied in one piece with the slide, or in two parts with the slide. This means for example that the actuating means must be disposed outside the housing of the power tool so that it can be actuated manually by the user.

A switch element includes at least one sensor element and at least one signal transducer. However, two or more sensor elements may also be associated with one signal transducer. For that purpose, two or more sensor elements may be disposed side by side, in such a way that the signal transducer, by axial displacement, activates the sensor elements successively. The sensor elements are disposed one after the other in the axial direction. A first sensor element may for instance be intended for switching the electric motor on and off, while a second sensor element may be used for instance for switching a lighting device, such as an LED, for lighting the work area on and off. Alternatively, two or more sensor elements may be disposed side by side such that the signal transducer, by axial displacement, activates and deactivates all the sensor elements simultaneously. This means that the sensor elements are disposed side by side transversely to the axial direction in which the signal transducer is movable.

In a second embodiment of the power tool of the invention, it is provided that the sensor element and the signal transducer are pivotable relative to one another, instead of being movable linearly, in particular axially, relative to one another. This can be achieved by embodying the sensor element as stationary and the signal transducer as pivotable, or vice versa. Preferably, the sensor element is embodied as structurally connected to the housing, while the signal transducer is pivotably supported. The signal transducer is preferably pivotable by being connected to a pivotably supported lever. In a simple embodiment, the signal transducer may be secured to the lever. The lever is connectable in turn to the second actuating means. This can be accomplished in a simple way by providing that the second actuating means is integrally formed onto the lever. The second actuating means, however, may also be connected detachably or nondetachably to the lever, for instance by clips or snaps or by engagement from behind or adhesive bonding. Since according to the invention the connection between the signal transducer and the actuating means is embodied rigidly, in the second embodiment the actuating means itself is pivotable.

A pivotably embodied switch element of this kind can be used for instance to select the clockwise or counterclockwise rotation of the drive spindle of the power tool.

In a refinement of the invention, the sensor element is disposed on a printed circuit board. Further electronic components may be disposed on the printed circuit board. Furthermore, one or more additional printed circuit boards may be provided, for accommodating the desired electronic components. In a battery-operated power tool, for supplying voltage, the printed circuit board may be connected electrically to the battery pack via voltage-carrying lines. The electric motor, among other elements, is also electrically connected to the printed circuit board via voltage-carrying lines.

In a further preferred embodiment, a switch housing is provided, in which at least the switch element, comprising at least one signal transducer and one sensor element, is received. The printed circuit boards and other electronic components may also be received in the housing. The housing forms a separate housing that is disposed in the housing of the power tool. It serves in particular as protection for the switch element and the electronic components on the printed circuit board. If the signal transducer is connected to the actuating means via a slide, then the slide protrudes at least partway into the housing. The actuating means is disposed on the end of the slide that protrudes from the housing. The housing moreover has the advantage that the housing that has the switch element can be combined with the printed circuit board, the electronic components, and the slide and the actuating means into a single module and inserted as a finished module into the power tool. If the electric motor of the power tool is an electronically commutatable electric motor, then the electronic components here for controlling the electronically commutatable electric motor can for instance be disposed on the printed circuit board. Thus the switch element for switching the electric motor on and off and the electronic components for controlling the electric motor may form a unit in the separate housing. The electronic control unit for the electric motor then no longer needs to be accommodated separately in a different place in the housing of the power tool.

Preferably, at least one part of the housing is of metal. The housing may for instance be formed in two parts comprising two half shells, with one housing part of metal and one housing part of plastic. The two housing parts are joined together, for instance by clips. The metal housing part then serves as a body capable of conducting heat, by way of which the heat of the electronic components can be dissipated. For that purpose, the surface of the metal housing part may additionally be profiled, for instance in the form of ribs, fluting, or other kind of raised or lowered areas that bring about an increase in the surface area.

In addition, a thermal conduction element of metal may also be provided, which is connected thermally conductively to the printed circuit board on the one hand and to the metal housing part on the other. The thermally conductive connection can be accomplished for instance by means of a thermally conductive adhesive. This likewise promotes the dissipation of heat from the electronic components on the printed circuit board.

In a preferred embodiment, the sensor element is a Hall sensor, and the signal transducer is a permanent magnet. Alternatively, however, still other active or passive sensor elements with a suitable signal transducer may be employed, such as sensor elements that are based on the piezoelectric effect or on electromagnetic induction or that function capacitively, magnetoresistively, inductively, galvanomagnetically, or optically. For instance, a read switch or an induction coil may be used as the sensor element, and in each case a permanent magnet can be used as the signal transducer. An optically based switch element can be attained by forming the sensor element by means of a system comprising an LED or photoelectric transistor. Between the LED and the photoelectric transistor, the signal transducer may either have a nontransparent surface to interrupt the beam of light from the LED or a reflective surface for the light of the LED, in order to transmit the beam of light.

The power tool of the invention may have a power cord or it may be a battery-operated power tool. This tool may be a screwdriver, drill, drill-screwdriver, drill hammer, or the like.

BRIEF DESCRIPTION OF THE DRAWINGS

The invention will be better understood and further objects and advantages thereof will become more apparent from the ensuing detailed description of preferred embodiments, taken in conjunction with the drawings, in which:

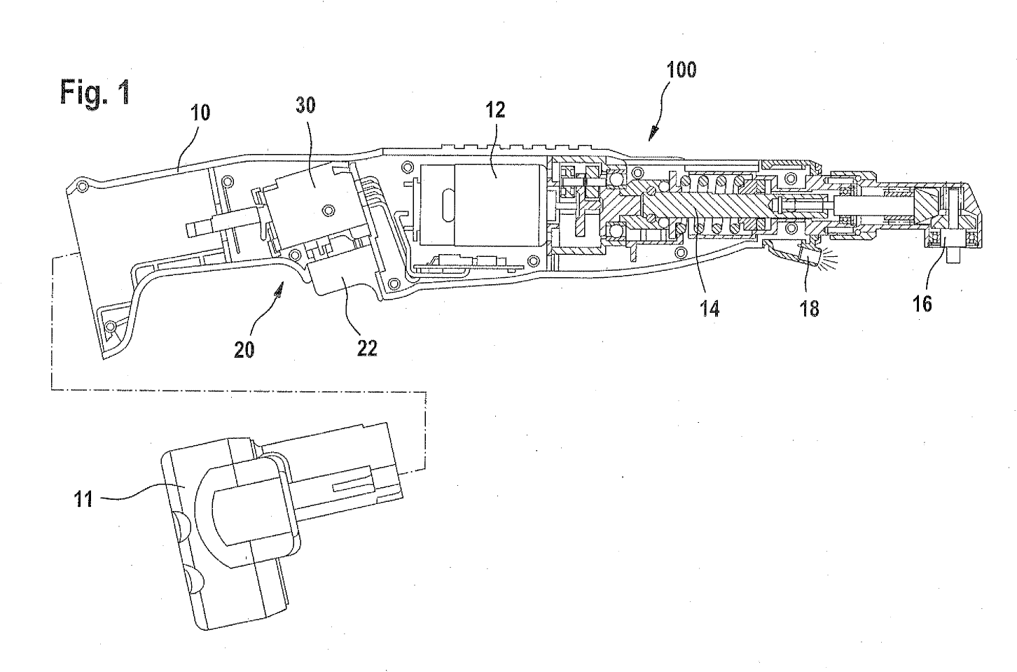

FIG. 1 shows one embodiment of a power tool of the invention in cross section;

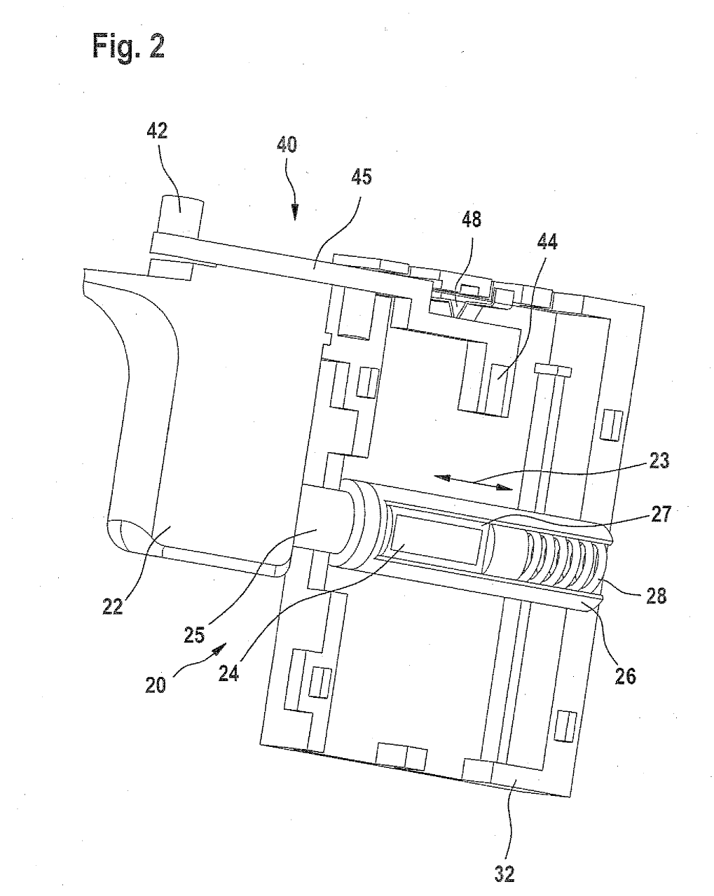

FIG. 2 shows parts of a first and second switch device, in a first and second embodiment, in perspective;

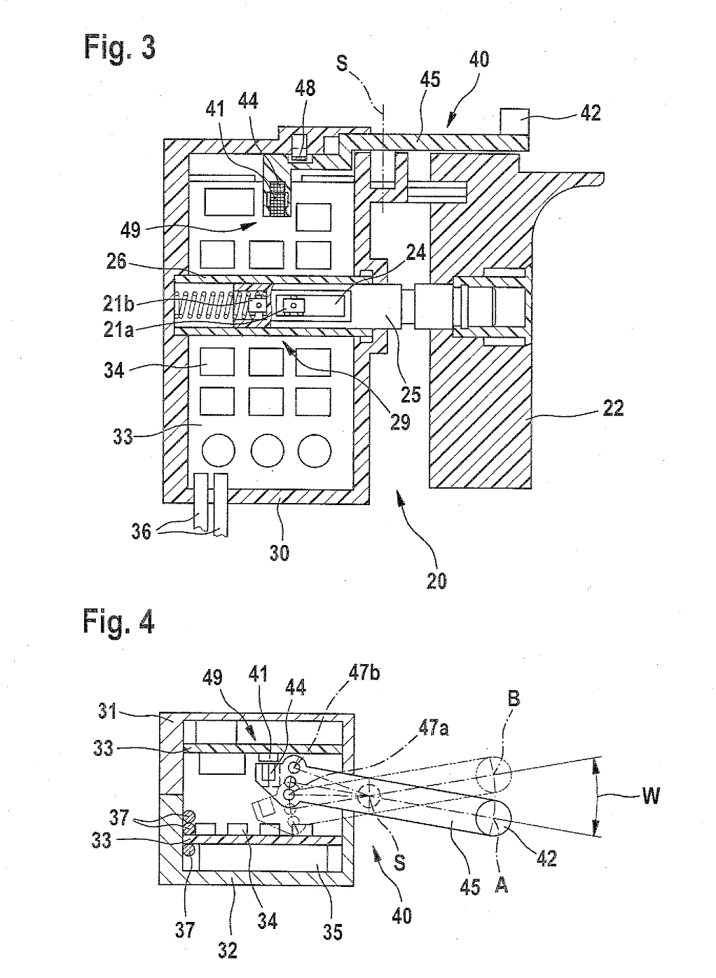

FIG. 3 is a longitudinal section through the switch devices of FIG. 2; and

FIG. 4 is a cross section through the switch devices of FIG. 2.

### DESCRIPTION OF THE PREFERRED EMBODIMENTS

In FIG. 1, a battery-operated right-angle screwdriver is shown, as an exemplary embodiment of a power tool 100 according to the invention. In the housing 10 of the power tool 100, an electric motor 12 for driving a drive spindle 14 is accommodated. The electric motor 12 may for instance be an electronically commutatable electric motor. Via the drive spindle 14, a tool insert (not shown) received in a tool receptacle 16 is driven. The electric motor 12 is supplied with power by a battery pack 11. The battery pack 11 also serves to supply voltage to an LED, which is provided as a lighting device 18 for illuminating the work area of the power tool 100. However, the invention is equally suitable for a power tool that has a power cord. The electric motor 12 and the lighting device 18 can be activated and deactivated via a contactless switch device 20 that has an actuating means 22 and a switch element 29, the latter including two sensor elements 21a and 21b and a signal transducer 24 (FIG. 2), in one housing 30.

FIG. 2 shows part of a first switch device 20 with the switch element 29 in perspective. The housing 30 comprises two housing parts 31, 32 in the form of half shells, of which in FIG. 2 only the housing part 32 is shown. In FIG. 2, a signal transducer 24 in the form of a permanent magnet is shown, which is movable linearly, in this case axially. The direction of motion of the signal transducer 24 is indicated by a double arrow 23. The signal transducer 24 is secured to a slide 25. The slide 25 is disposed axially movably in a guide element 26 in the form of a guide sleeve. The guide element 26, in the region of the signal transducer 24, has an opening 27, for instance in the form of a slot, window, or the like. The slide 25 protrudes partway out of the housing 30. Outside the housing 30, the slide 25 is rigidly connected to the actuating means 22, for instance by clips. Thus the slide 25 can be axially moved in that the user moves the actuating means 22 axially in the direction marked by the double arrow 23. The slide 25 is supported under spring loading, so that upon actuation of the actuating means 22 in the direction of the housing 30, the slide 25 is moved counter to the compressive force of a spring element 28, in this case a helical spring.

From FIG. 3, it can be seen that in the housing 30, at the level of the slide 25 with the signal transducer 24, two sensor elements 21a and 21b in the form of Hall sensors are disposed on a printed circuit board 33. The signal transducer 24 and the sensor elements 21a, 21b form the contactless switch element 29. By axial displacement of the slide 25 in the guide element 26, the signal transducer 24 is made to coincide first with the first sensor element 21a and then with the second sensor element 21b, as a result of which the two sensor elements 21a and 21b can be activated and deactivated in contactless fashion. The opening 27 is provided in the guide element 26 so that the signal transducer 24 and the sensor element 21 can be provided with electrical contact. In the position of the slide 25 as shown in FIG. 3, the first sensor element 21 a has just been made to coincide with the signal transducer 24. If the slide 25 is pressed onward as far as a stop counter to the compressive force of the spring element 28, the signal transducer 24 covers both sensor elements 21a, 21b. In the embodiment shown, two sensor elements 21a, 21b are thus associated with one signal transducer, and the sensor elements 21a, 21b are disposed side by side in such a way that by axial motion of the signal transducer 24 by means of the actuating means 22, the sensor elements 21a, 21b are activated and deactivated in succession. They are accordingly disposed one after the other in the axial direction 23. The first sensor element 21a serves for instance to turn the lighting device 18 on and off, and the second sensor element 21b serves to switch the electric motor 12 on and off.

In FIGS. 2 through 4, a second switch device 40 in a second embodiment is also provided, with an actuating means 42 and a contactless switch element 49. The contactless switch element 49 serves to select the clockwise/counterclockwise rotation of the right-angle screwdriver. The switch element 49 includes a sensor element 41 in the form of a Hall sensor and a signal transducer 44 in the form of a permanent magnet. The sensor element 41 is again disposed on a printed circuit board 33. The signal transducer 44 is connected to a lever 45, being secured to the lever 45. The lever 45 protrudes partway into the housing 30. On its free end outside the housing 30, the lever 45 is provided with an actuating means 42, which the user of the power tool 100 can actuate manually. The lever 45 is pivotably supported. It can be pivoted about an angle W about a pivot axis S between two positions A and B. In position A, the signal transducer 44 is brought into coincidence with the sensor element 41 without mechanical contact, as a result of which the switch element 49 is provided with electrical contact in contactless fashion. In position B, the signal transducer 44 and the sensor element 41 are spaced apart so far from one another that no electrical contact is made. A spring element 48 is disposed in the housing 30. It defines the terminal positions A and B of the lever 45; in the region of the end protruding into the housing 30, the lever 45 has indentations 47a and 47b into which the spring element 48 snaps.

Electronic components 34 are also disposed on the printed circuit boards 33. The electronic components 34 may for instance serve to control the electronically commutatable electric motor 12. If the electronic control unit is disposed in the region of the switch device 20, 40, then this has the advantage that they are located comparatively far away from the electric motor 12 and are thus not so markedly exposed to the electromagnetic interfering radiation of the electric motor 12. The printed circuit boards 33 are electrically connected to the power supply of the power tool 00, for instance to the battery pack 11, by means of voltage-carrying lines 36. Via electric lines 37, the electric motor 12 is electrically connected to the printed circuit board 33. The housing 30 surrounds the switch elements 29, 49 as well as the printed circuit boards 33 and the electronic components 34, and as a result the vulnerable components are better protected. The housing part 32 is of metal and can thus better dissipate the heat that is developed by the electronic components. In addition, a thermal conduction element 35 of metal is provided, which is connected to the metal housing part 32 on the one hand and to the printed circuit board 33 on the other in thermally conductive fashion, for instance by means of a thermally conductive adhesive.

The foregoing relates to preferred exemplary embodiments of the invention, it being understood that other variants and embodiments thereof are possible within the spirit and scope of the invention, the latter being defined by the appended claims.

I claim:

1. A power tool comprising at least one contactless switch element including at least one sensor element and at least one signal transducer, and an actuating means for actuating the switch element, the sensor element or the signal transducer being connected rigidly to the actuating means.

2. The power tool of claim 1, wherein the sensor element and the signal transducer are movable linearly, in particular axially, relative to one another.

3. The power tool of claim 1, wherein the sensor element is disposed in stationary fashion by being structurally connected to the housing.

4. The power tool of claim 1, wherein the sensor element is disposed in stationary fashion by being structurally connected to the housing.

5. The power tool of claim 1, wherein the signal transducer is embodied axially movably.

6. The power tool of claim 2, wherein the signal transducer is embodied axially movably.

7. The power tool of claim 5, further comprising a spring element, the signal transducer being axially movably counter to the compressive force of the spring element.

8. The power tool of claim 5, further comprising a slide and a guide element, the signal transducer being connected to the slide, and the slide being axially displaceable by means of the guide element.

9. The power tool of claim 8, wherein the slide is connected to the actuating means.

10. The power tool of claim 1, further comprising a plurality of sensor elements disposed side by side, such that the signal transducer, by axial displacement, activates the sensor elements successively.

11. The power tool of claim 1, wherein the sensor element and the signal transducer are embodied as pivotable relative to one another.

12. The power tool of claim 11, wherein the sensor element is disposed in stationary fashion, in particular being structurally connected to the housing, and the signal transducer is supported pivotably.

13. The power tool of claim 12, further comprising a pivotable support lever operable to pivot the signal transducer.

14. The power tool of claim 13, wherein the lever is connected to the actuating means.

15. The power tool of claim 1, further comprising a printed circuit board, the sensor element being disposed on the printed circuit board.

16. The power tool of claim 15, further comprising a housing, and wherein at least the switch element is disposed in the housing.

17. The power tool of claim 16, wherein at least one part of the housing is of metal.

18. The power tool of claim 17, further comprising a thermal conduction element connecting the printed circuit board to the metal housing part.

19. The power tool of claim 15, wherein the printed circuit board comprises electronic components for controlling an electronically commutatable electric motor.

20. The power tool of claim 1, wherein the sensor element is a Hall sensor, and the signal transducer is a permanent magnet.
